(19) United States
(12) Patent Application Publication
(10) Pub. No.: US 2018/0168918 A1
(43) Pub. Date: Jun. 21, 2018

(54) MYOFASCIAL MASSAGE DEVICE

(71) Applicant: Daniel Liburd, Pittsburgh, PA (US)

(72) Inventor: Daniel Liburd, Pittsburgh, PA (US)

(21) Appl. No.: 15/848,093

(22) Filed: Dec. 20, 2017

Related U.S. Application Data
(60) Provisional application No. 62/436,742, filed on Dec. 20, 2016.

(51) Int. Cl. A61H 15/00; A61H 9/00

(52) U.S. Cl. CPC A61H 15/0092; A61H 9/0057; A61H 2015/0021; A61H 2015/0042; A61H 2015/005; A61H 2015/0057; A61H 2009/0064; A61H 2201/1253; A61H 2201/0161; A61H 2201/0192; A61H 2201/1671; A61H 2201/1695; A61H 2201/0157

(57) ABSTRACT

A multifunctional massage device is disclosed. Aspects of embodiments of the device contemplate a number of different therapeutic components featuring massaging elements. The different therapeutic components may be used to independently or simultaneously deliver therapeutic massages to different parts of a user's body. After use, sections of the different components may be stowed away within a hollow tubular cane or cylinder by use of a connecting device.

### CROSS-REFERENCE TO RELATED APPLICATIONS

This Application claims the benefit of, and is related to, Applicant's provisional patent application, U.S. Provisional Patent Application No. 62/436,742 titled “MYOFASCIAL MASSAGE DEVICE” filed Dec. 20, 2016, which is incorporated herein in its entirety.

### FIELD OF THE INVENTION

The present invention relates generally to massage and myofascial muscular treatment tools and, more particularly, to a myofascial massage device that, in addition to treating muscle and fascia by the application of pressure, is able to simultaneously pull and separate, skin, muscle or fascia to improve blood flow, innervate tissue and effectively remove adhesions. The contemplated device combines, into one device or tool, three integral tool pieces for the treatment of a variety of body parts and tissues.

### BACKGROUND

The background information discussed below is presented to better illustrate the novelty and usefulness of the present invention. This background information is not admitted prior art.

Mobility difficulties for people of all ages are common and lead to poor performance of daily activities. For many, physical mobility barely requires conscious thought. For others, compromised physical mobility leads to difficulty moving without considerable effort and pain. Mobility can be disrupted by tensile stress, acute injury, overuse of muscular structure and natural degenerative changes, for example. Stress and/or injury often result in for formation of muscle or myofascial adhesions that can further limit the potential range of motion around a joint. In the body, adhesions are a type of scarring or are scar tissue that causes soft body tissues, such as fascia, to adhere to other body tissue, which can cause interference with blood and nerve impulse supply to various parts of the body. Fascia may be one of the most important structures in the musculoskeletal system as it forms a “fascial structure” that interconnects throughout the entire body and acts to hold muscles and bones together contributing to posture and movement quality which ultimately results in the body's ability to generate power, speed and agility. Fascia, when healthy and free from adhesions, forms a free gliding interface between and within muscles, allowing free movement to occur. When fascia, muscles, tendons, and ligaments get mechanically overloaded, injury can occur resulting in fibrosis and adhesions that restrict bodily movement. Adhesions occur most frequently under the skin within the fascia layers. However, they also occur within cell membranes, intracellularly, in and on muscles, tendons, ligaments, skin, organs and elsewhere. In all cases, they involve a hardening, toughening or fibrosis of the body tissues. The main cause of adhesions appears to be inflammation. Inflammation can be caused by dietary problems, infections, cancer, radiation and trauma, such as from surgery, a fall, or by the stress resulting from sport activities.

Some adhesions can be quite superficial and temporary, such as tightness in a muscle after exercise and can be worked-out easily and quickly as they usually only involve two adhered tissues. Others are more difficult to treat, as they can involve multiple layers of fascia, connective tissue or other organs and tissues. The common objective in improving mobility is to remove muscle or myofascial adhesions. Today there are several approaches to soft tissue management including fascial manipulation using stretching exercises, massage, and manipulation of the tissues.

Several techniques used in major professional sports, Ironman competitions and the Olympics include the Active Release Technique (ART) which is a hands-on treatment that reestablishes normal motion in and between fascial planes thereby reducing the adhesions that occur in the fascia and muscle while restoring the normal “gliding” and range of movement of these structures. The practitioner using ART would use manual force to essentially first shorten then lengthen the muscle and fascia to provide a free and complete movement of the structure treated, releasing adhesive tissue restrictions, increasing blood flow and restoring a more complete range of movement.

Another technique used is the Graston Technique which uses specific stainless-steel tools of different shapes that are used in many different directions over a fibrous “lesion” or scar tissue. This soft tissue technique is designed to mobilize, reduce and reorganize fibrotic scar tissue or restrictions and can be very helpful in the repair and especially remodeling phase of inflammation. Graston is also very effective for chronic or long standing soft tissue adhesions especially causing range of motion restriction for a joint. Fascial Manipulation (FM) focuses on treating what is known as individual “myofascial units” or trigger point locations along a “myofascial sequence” or specific chain of trigger points. Another technique, known as FAKTR-PM, uses hands-on therapy during corrective exercise to restore fascial “gliding” using functional movement patterns during treatment to restore proper timing and sequence to complex movement.

Many mechanical devices in the form of scrapers, rollers, as well as pulsating or vibrating objects are used for the treatment of fascia and the removal of tissue adhesions. However, currently available massage devices are bulky. In addition, each massage device is limited to a single purpose, and/or do not allow for adequate treatment of different body parts and conditions.

Existing devices function on the principle of “one size fits all”. The need for a multiplicity of tools often forces users to rely on a variety of non-compatible devices to address multi-faceted needs. This in turn results in patients foregoing treatment, increased expenses as well as problems with clutter and storage. Moreover, current devices are not designed to simultaneously treat different muscle groups. Accordingly, there is a need for a compact multi-functional myofascial massage device that can be rapidly and easily reconfigured to target different anatomical areas while simultaneously treating different muscle groups.

### SUMMARY OF THE INVENTION

The present Inventor recognized that while muscle and fascia treatment can be addressed using the above described massage tools to apply pressure, these tools are not able to pull muscle or fascia to improve blood flow and effectively remove adhesions. Moreover, he recognized that to treat the muscle tissue and fascia in different parts of the body variously shaped and sized tools are required and while a variety of tools can be comprehensive in care, they also are inconvenient for travel and many tools pose a greater risk for one or more being lost.

As such an aspect of an embodiment of the present invention contemplates a therapeutic massage device, which may include: a hollow tubular cane or cylinder having a first and a second end and an inner diameter, a first therapeutic component, which may include a roller rotatably disposed about the hollow tubular cane or cylinder, a second therapeutic component which may include any one or more of: one or more rollers or one or more spheres, a third therapeutic component which may include any one or more of: at least two spheres of similar radii or a combination of one or more spheres having a first radius and another sphere having a second radius, and a connecting device connecting the hollow tubular cane or cylinder with the second and third therapeutic components.

In an aspect of an embodiment of the present invention, the roller of the first therapeutic component may further include the following: a compression and traction section and one or more suction cups positioned on the compression and traction section.

In an aspect of an embodiment of the present invention, the roller may include one or more protrusion extending perpendicularly from the compression and traction section of the first therapeutic component, where the protrusion may be located at a position at any one of: in close proximity with the one or more suction cups or inside the one or more suction cups.

In an aspect of an embodiment of the present invention, the hollow tubular cane or cylinder may include a handle at each of the first and second ends of the hollow tubular cane or cylinder. In another aspect of an embodiment of the present invention, each handle may be rotatably positioned about the hollow tubular cane or cylinder.

In an aspect of an embodiment of the present invention, the connecting device may be any one of: a cord, rope or wire. In another aspect of an embodiment of the present invention, the connecting device may be any one of: several connected sections, unconnected sections or one single length.

In an aspect of an embodiment of the present invention, the connecting device may extend through the second therapeutic component, through the hollow tubular cane or cylinder, through first and second fenestrations on the hollow tubular cane or cylinder's surface, and through the third therapeutic component.

In an aspect of an embodiment of the present invention, the therapeutic massage device may include a cord retrieval unit positioned about the section of the connecting device extending from the first and second fenestrations of the hollow tubular cane or cylinder. In another aspect of an embodiment of the present invention, the cord retrieval unit may be structurally configured to allow for length adjustment of the connecting device or length adjustment of sections of the connecting device.

In an aspect of an embodiment of the present invention, the second therapeutic component may include a large therapeutic roller or sphere flanked by two or more smaller rollers or spheres, where each of the smaller rollers or spheres have an outer diameter slightly less than the hollow tubular cane or cylinder's inner diameter, and where the large therapeutic roller or sphere has a diameter which is larger than the hollow tubular cane or cylinder's inner diameter. In another aspect of an embodiment of the present invention, each of the large roller or sphere and the smaller rollers or spheres may include an aperture through which allows the connecting device to run through

In an aspect of an embodiment of the present invention, the third therapeutic component may include differently shaped objects in succession with each other, where each differently shaped object comprises of an aperture through which connecting device may run through. In another aspect of an embodiment of the present invention, each differently shaped object may have an outer diameter which is smaller than the hollow tubular cane or cylinder's inner diameter

In aspects of embodiments of the present invention, the contemplated multi-use myofascial massage device may combine distinct or separate massage units or components into a single unit for use on the body and for treatment of muscular groups in an efficient manner. In one aspect of an embodiment of the present invention, the multi-use myofascial massage device may include a roller that is effective in applying the pressure required to effectively treat muscle and fascia as well as being able to effectively separate fascia from skin to treat tissue by improving blood flow and by removing mechanically disruptive adhesions. The multi-use myofascial massage device enables individuals to take care of various specific areas from the feet to the neck with ease and convenience with minimal effort and time and in a cost-effective manner. The multi-use myofascial massage device enables athletes to travel without fear that one or more single use tools, that are critical to massage or myofascial therapy, will be lost. The multi-use tool provides movement specialists and trainers the opportunity to provide treatment in a comprehensive manner in their efforts to help relieve muscle adhesion. Thus, it will be shown that although many massage roller application devices have been invented and marketed to roll and apply pressure to the muscles to disrupt adhesions in fascia, until the present invention, no artisan had achieved a device to both apply pressure to the skin and also pulls the skin to further disrupt fascia and increase blood flow and to do so in a one-piece device. To effectively treat muscle and fascia, an elongate roller having suction cups on its outer surface is used to effectively separate fascia from skin. To do this, the person conducting the treatment firmly presses this roller against the skin of the area to be treated. The application of firm pressure provides a disruptive force to collagen fibers and enables the suction cups to adhere to the skin of the area being treated. Gentle, but firm repeated rolling of the roller over the area to be treated first causes a row of suction cups to adhere to the patient's skin and then continued rolling removes that row of suction cups. With further continued rolling another row of suction cups is adhered to the patient's skin and subsequently removed. This repetitive action results in the separation of skin from fascial to improve blood flow and mechanically disrupt the connection between tissue and adhesion resulting in the effective removal of adhesions to once again allow a free gliding movement interface between fascia and muscles. Additional, roller or spheres having less surface area because of their reduced size are used, similarly, to apply the pressure required to improve blood flow and remove mechanically disruptive adhesions of the muscle groups that are not easily treated using the elongate roller.

Still other benefits and advantages of this invention will become apparent to those skilled in the art upon reading and understanding the following detailed specification and related drawings.

### Definitions

Fascia, as used herein, is a band or sheet of connective tissue, primarily collagen, beneath the skin that attaches, stabilizes, encloses, and separates muscles and other internal organs. Fascia is classified by layer, as superficial fascia, deep fascia, and visceral or parietal fascia, or by its function and anatomical location. Like ligaments, aponeuroses, and tendons, fascia is made up of fibrous connective tissue containing closely packed bundles of collagen fibers oriented in a wavy pattern parallel to the direction of pull. Fascia is consequently flexible and able to resist great unidirectional tension forces until the wavy pattern of fibers has been straightened out by the pulling force. These collagen fibers are produced by fibroblasts located within the fascia. Fasciae are similar to ligaments and tendons as they have collagen as their major component. They differ in their location and function: ligaments join one bone to another bone, tendons join muscle to bone, and fasciae surround muscles or other structures.

Tensile stress (or tension) is the stress state leading to expansion; that is, the length of a material tends to increase in the tensile direction. The volume of the material stays constant. When equal and opposite forces are applied on a body, then the stress due to this force is called tensile stress.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict an example of the present invention and therefore, are not to be considered limiting in scope, thus, the invention is described with explanatory specificity and detail through the use of the accompanying drawings, in which:

FIG. 1 is a perspective view of the myofascial massage device according to an aspect of an embodiment of the present invention.

FIG. 2 is another perspective view of the myofascial massage device illustrating a cord retrieval unit according to an aspect of an embodiment of the present invention.

FIG. 3 is a further perspective view of the myofascial massage device illustrating the myofascial massage device in travel mode according to an aspect of an embodiment of the present invention.

FIG. 4 is a perspective view of a cord retrieval unit and fenestrations of the myofascial massage device according to an aspect of an embodiment of the present invention.

### A LIST OF THE REFERENCE NUMBERS AND STRUCTURE TO WHICH THEY REFER

10 Myofascial massage device
12 Connecting device
12A First section of connecting device
12B Second section of connecting device
14 Grasping handles
16 Hollow support cane or cylinder
18 A first end of support cane or cylinder 16
19 A second end of support cane or cylinder 16
20 First therapeutic component
22 Suction cups
24 Compression and traction surface of first roller 20
26 Cord retrieval unit
28 Adhesive coating
30 Second therapeutic component
32A Large-sized element of second therapeutic component 30
32B Smaller-sized element of second therapeutic component 30
40 Third therapeutic component
42 Small-sized element of third therapeutic component 40
44 Larger-sized element of third therapeutic component 40
46 Fenestrations

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, and forms. Therefore, the embodiment described herein is provided with the understanding that the present disclosure is intended as illustrative and is not intended to limit the invention to that embodiment.

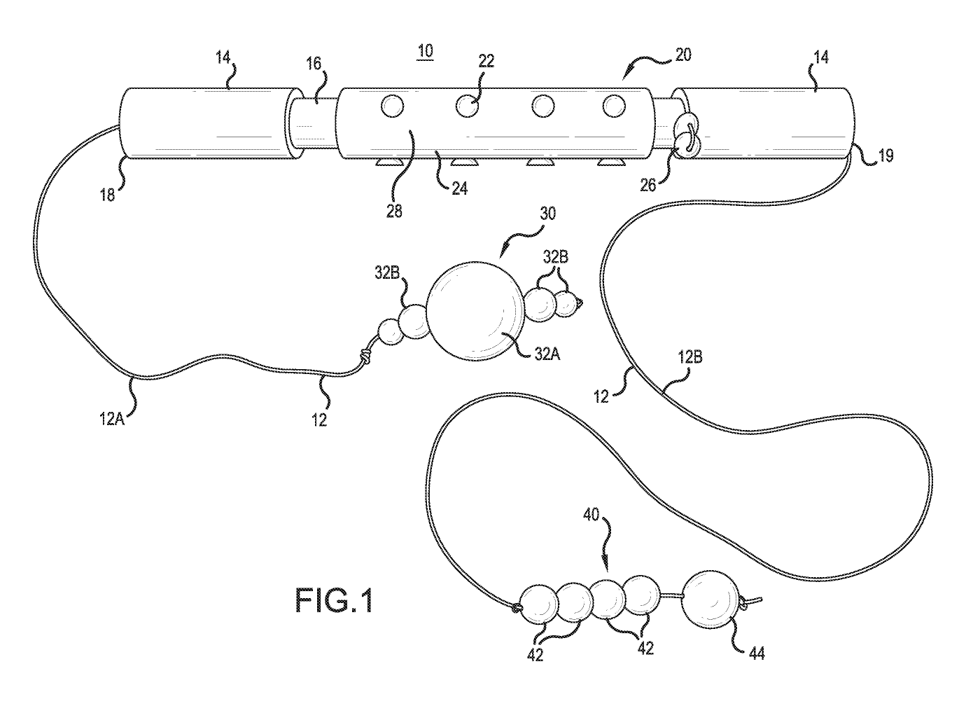

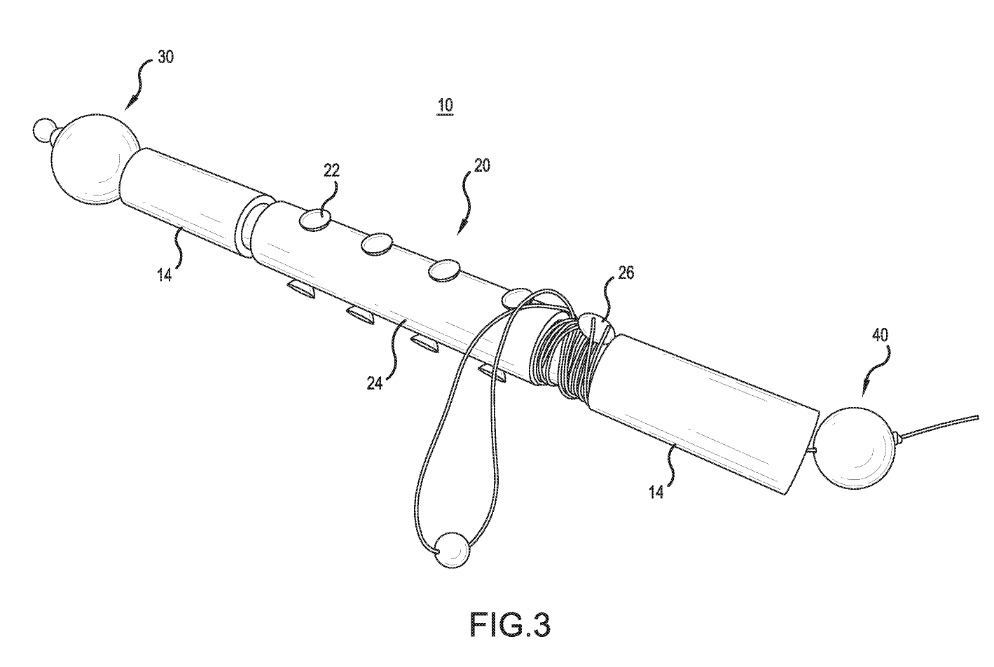

Referring now to FIGS. 1-4, different views of a length-adjustable myofascial massage device 10 are shown according to aspects of embodiments of the present invention. In an aspect of an embodiment of the present invention, myofascial massage device 10, as illustrated in FIG. 1, includes at least one therapeutic component. In one aspect, this may include a roller. In another aspect, myofascial massage device 10 may include three discreet but physically connected therapeutic sections: first therapeutic component 20; second therapeutic component 30 and third therapeutic component 40. In aspects of embodiments of the present invention, second and third therapeutic components (elements 30 and 40) may include any one or more of one or more rollers or one or more spheres. The three discreet therapeutic sections or components may be connected by connecting device 12. In an aspect of an embodiment of the present invention, connecting device 12 may be any one or more of a cord, rope, wire or the like. In another aspect of an embodiment of the present invention, connecting device 12 may be made of any material that will perform the required function. Additionally, the connecting device 12 may be of several connected sections or of a single length.

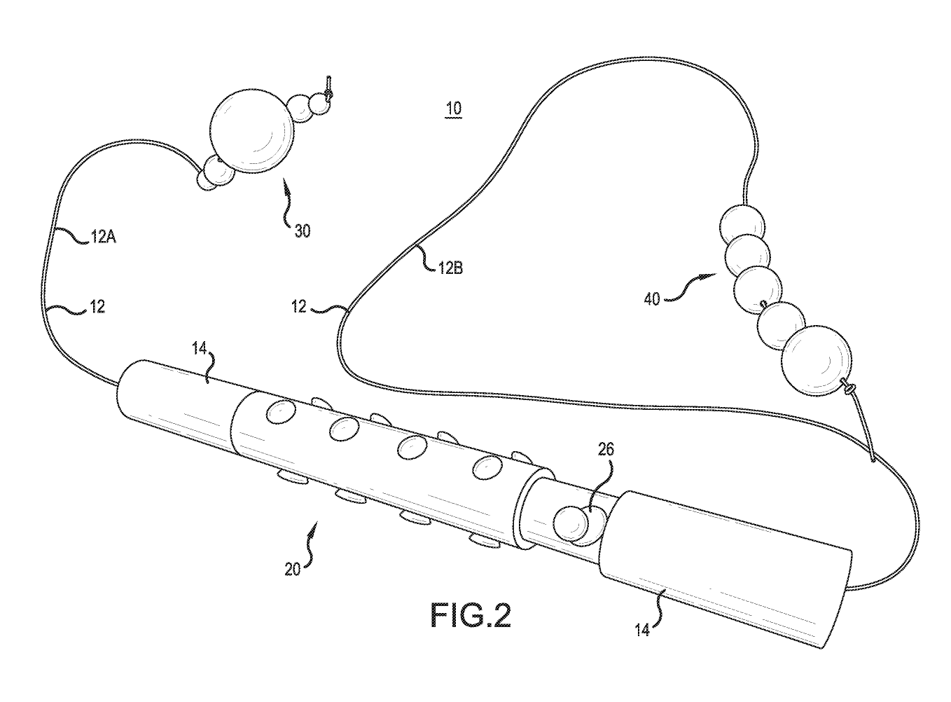

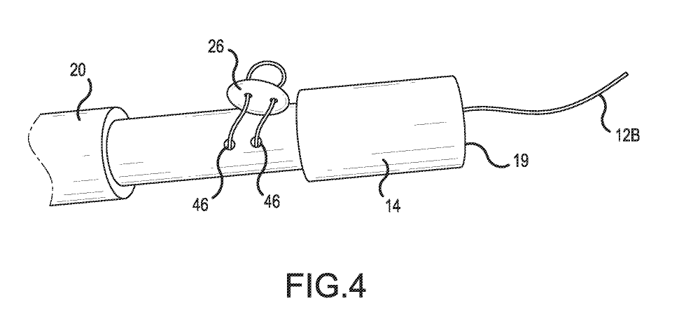

First therapeutic component 20 is a hollow tube or roller having an inner diameter that enables therapeutic component 20 to be rotatably positioned about and supported by hollow tubular cane or cylinder 16. The outer surface of first therapeutic component 20 includes compression and traction section 24 having suction cups 22 emanating therefrom. Hollow tubular cane or cylinder 16 terminates in first end 18 and second end 19. On or at each of first end 18 and second end 19 of hollow tubular cane or cylinder 16 is positioned handle cover 14 which may be used as grasping handles for holding myofascial massage device 10 while using therapeutic component 20. Extending out from first end 18 of hollow tubular cane or cylinder 16 is connecting device 12 and extending from second end 19 is another section of connecting device 12. Connecting device 12 may be made of material that enables it to be both pliable and elastic. Attached to a section of connecting device 12 is cord retrieval unit 26 (best viewed in FIG. 2). In an aspect of an embodiment of the present invention, cord retrieval unit 26 may be fixedly supported or positioned on the outer surface of hollow tubular cane or cylinder 16 in a space that exists between each of handles 14 and compression and traction section 24 of first roller 20. Cord retrieval unit 26 provides for both sections 12A & 12B of connecting device 12 to be length adjustable. Length adjustable refers, in part, to the functionality of connecting device 12. When both first section 12A of connecting device 12 (which attaches second therapeutic component 30 to cord retrieval unit 26) and second section 12B of connecting device 12 (which attaches third therapeutic component 40 to cord retrieval unit 26) are completely retracted by action of cord retrieval unit 26 then most of connecting device 12 is positioned for storage within hollow tubular cane or cylinder 16 hidden from view. However, when first section 12A of connecting device 12 is extended to full length, second therapeutic component 30 can be extended to enable its use at the feet of a person being treated while third therapeutic component 40 can be used simultaneously on upper extremity muscle and/or fascia. This enables the user to focus on more than one area when treating or massaging muscle tissue. In the example illustrated, a first end of first section 12A of connecting device 12 may be functionally attached to cord retrieval unit 26 and a second end of first section 12A of connecting device 12 may be attached to second therapeutic component 30. This provides for first section 12A of connecting device 12 to be lengthened or shortened as required. When second therapeutic component 30 is to be used, first section 12A of connecting device 12 will be lengthened and when the myofascial massage device 10 is to be stored, for storage or transport, first section 12A of connecting device 12 will be shortened so that most of connecting device 12 will be conveniently stored or stowed within hollow tubular cane or cylinder 16. Similarly, there is a first and a second end of a second section 12B of connecting device 12 that connects third therapeutic component 40 to cord retrieval unit 26 in order the shorten and lengthen second section 12B of connecting device 12 as required. It should be understood that cord retrieval unit 26 could be positioned on any desired location on or within hollow tubular cane or cylinder 16 as long as the position of cord retrieval unit 26 provides the desired function of acting as a cord lengthening and shortening device. It also should be understood that core retrieval unit 26 can be of any design that encompasses a cord stopper and a cord puller. In the example illustrated in FIGS. 2 and 4, cord retrieval unit 26 may be positioned over two pin holes or fenestrations 46 located on hollow tubular cane or cylinder 16. These fenestrations 46 lead to the inner portion of hollow tubular cane or cylinder 16. In another aspect of an embodiment of the present invention, these fenestrations 46s may be positioned just on each side of, cord retrieval unit 26. The two pin holes or fenestrations 46s enable the two sections of connecting device 12 to be pulled in and out of the inner portion of hollow tubular cane or cylinder 16. It should be noted that while an aspect of an embodiment of the present invention calls for first and second fenestrations 46, other aspects of embodiments of the present invention contemplate more than two fenestrations 46, enabling different operational abilities for adjusting the lengths of connecting device 12 and/or its corresponding sections 12A and 12B.

In an aspect of an embodiment of the present invention, cord retrieval unit 26 may include a covering (not shown) that prevents users from seeing connecting device 12 when connecting device section 12A and 12B of myofascial massage device 10 are fully retracted. The covering may be removably attached to cord retrieval unit 26 or, in another aspect, it may be part of cord retrieval unit 26.

The combination of the first therapeutic component 20, second therapeutic component 30 and third therapeutic component 40 cooperate to form a portable multi-use massager for massaging and treating a person's muscles and/or fascia. First therapeutic component 20, in one aspect of an embodiment of the present invention, is the central therapeutic section or component of this three-component device. In an aspect of an embodiment of the present invention, the circumferential outer surface of first therapeutic component 20 may include compression and traction section 24, which in one aspect may include one or more suction cups 22 extending outward from it. If desired, both, or either of, circumferential outer surface comprising compression and traction section 24 and suction cup(s) 22 may be treated with adhesive coating t28 o enhance the adhesion of the compression and traction section 24 and suction cup(s) to skin of the person undergoing treatment. Additionally, if desired, compression and traction section 24 may include one or more small protrusions (not shown) positioned near, or inside, each of suction cup(s) 22 to assist in providing mechanical pressure to muscle or fascia. In an aspect of an embodiment of the present invention, suction cup(s) 22 may be varied in size. In an aspect of an embodiment of the present invention, each suction cup 22 may have a cup diameter ranging from about 5 mm to 5 cm. While exemplary diameters of suction cup(s) 22 have been disclosed, aspects of embodiments of the present invention contemplate other diameters.

In an aspect of an embodiment of the present invention, hollow tubular cane or cylinder 16 may be of any length ranging from about 3 inches to about 50 inches, and an inner diameter ranging from about 1 to about 20 cm. In an aspect of an embodiment of the present invention multiple massage balls may have diameters ranging from 1 cm to slightly less than 20 cm and may be stored within hollow tubular cane or cylinder 16 to facilitate transporting. While exemplary lengths and diameters have been disclosed, aspects of embodiments of the present invention contemplate other lengths and diameters.

In an aspect of an embodiment of the present invention, second therapeutic component 30, positioned about one end of connecting device 12, may include one large therapeutic roller or sphere 32A flanked by two or more smaller rollers or spheres 32B. In an aspect of an embodiment of the present invention, each of the two or more smaller rollers or spheres 32B may have an outer diameter slightly less than the diameter of hollow tubular cane or cylinder 16. In another aspect of an embodiment of the present invention, each of the two or more smaller rollers or spheres 32B may have an outer diameter less than the diameter of hollow tubular cane or cylinder 16, thereby enabling second therapeutic component 30 to be completely retracted into hollow tubular cane or cylinder 16. In another aspect of an embodiment of the present invention, second therapeutic component 30 may include a combination of any one or more of one or more rollers or one or more spheres. Each roller or sphere 32A, 32B may include an aperture through which connecting device 12 is placed. Second therapeutic component 30, is illustrated, as having spheres in succession. However, second therapeutic component 30 is also contemplated to include differently shaped objects in succession and it should be understood that these are not limited to the shape of a roller or a sphere. Additionally, the objects that form second therapeutic component 30 may be held in succession over an axis that can be a cord or any other cord like device that can be lengthened or shortened.

In an aspect of an embodiment of the present invention, third therapeutic component 40 may contain two or more smaller diameter rollers or spheres 42 that each have an outer diameter slightly less than the inner diameter of hollow tubular cane or cylinder 16. In another aspect of an embodiment of the present invention, third therapeutic component 40 may include a combination of any one or more of one or more rollers or one or more spheres. In another aspect of an embodiment of the present invention, each of the two or more smaller diameter rollers or spheres 42 may have an outer diameter less than the inner diameter of hollow tubular cane or cylinder 16, thereby enabling third therapeutic component 40 to be completely retracted into hollow tubular cane or cylinder 16.

In another aspect of an embodiment of the present invention, third therapeutic component 40 may also have one or more roller spheres 44 that has an outer diameter exceeding that of the two or more smaller diameter rollers or spheres 42. Each sphere, regardless of the size of its outer diameter, may have an aperture therethrough for the insertion of connecting device 12. In another aspect of an embodiment of the present invention, larger roller or sphere 44 may have an outer diameter that is slightly larger than the inner diameter of hollow tubular cane or cylinder 16. In a further aspect, each roller sphere 42 may be placed in succession on one end of connecting device 12 with larger roller or sphere 44 at the outer end of connecting device 12.

Connecting device 12, in the example illustrated, is attached to cord retrieval 26 mechanism providing for connecting device 12 to be increased or shortened in length as required. Alternatively, connecting device 12 may be made of an elastic material that stretches in length as required. Each of the rollers or spheres is made of either a non-compressible material, such as wood, or a compressible material, such as rubber, as desired.

Fascia is considered to be a dense irregular connective tissue that surrounds both muscle and its integral parts including myofibrils as well as other organs in the body. When authors describe fascia they often describe it as a whole rather than in parts. This description attests to fascia's unique connective characteristics and its ubiquitous nature. Fascia has often been explained as the “continuity tissue” and the “organ of form”. These unique qualities lead many movement specialists to regard fascia as an important tissue not only for posture and movement, but for its restoration in movement. Treatment of fascia has centered on its dense nature. The most common methodology for treating fascia involves manipulation of fascial tissue by way of mechanical pressure. Pressure applied to fascia may help to decrease the density of fascia and transform it from solid to a more fluid structure.

The application of mechanical stress is thought to disrupt the collagen fibers that comprise the fascial body. As such, myofascial massage device 10 is an effective tool for the application of mechanical stress needed to disrupt the properties of fascia as it applies both pressure and shear stress. Myofascial massage device 10 is also an efficient means of applying mechanical pressure and shear stress to areas such as the superficial layer of fascia that sits just underneath the skin and the deep layer of fascia that is located beneath the superficial layer. The application of shear stress to fascia tissue is applied through the pulling of the skin created from the vacuumed-formed seal of suction cups 22. This push and pulling mechanism helps to manipulate the superficial layer of fascia. This action also can generate blood flow in these areas as they contain a rich blood supply. It also can help to innervate nerve tissue as the superficial layer is also rich in nerve supply. In fact, authors of myofascial treatment suggest that treatment of these fascial layers may play an important role in proprioception, balance and nociception. The pressure of the roller can help to apply the force needed to manipulate the dense fascia underneath. Myofascial massage device 10 is an exemplary means of manipulation of tissue as it provides both mechanical pressure and shear stress to tissue. Whereas previous rollers have focused on mechanical pressure, none have combined both mechanical pressure and shearing by pulling of the skin as a method of manipulation. Myofascial massage device 10 has the ability to perform this unique push-pull application of mechanical pressure and shearing of the skin as a result of suction cups 22 along hard roller surface 24. The semi-sphered cup-like structures of suction cups 22 form a tight seal because as air escapes a vacuum is created resulting in a tight seal of the cups to the skin. As roller 20 moves about its axis applying pressure to the skin, there is concomitant pulling that occurs as suction cups 22 roll and tug the skin from the vacuum sealed cups. The unique pushing and pulling action achieved by first roller 20 occurs because of the innovative combined use of compression and traction surface 24 with suction cups 22 attached to the compression and traction surface 24, with or without the addition of an adhesive on the surface of compression and traction surface 24, suction cups 22, or both.

The varying nature of fascia requires a multilateral approach to treatment. Especially as we consider the various differences between fascial structures around the body. Fascia in the feet differ from fascia of the upper leg. Some fascial structures tend to be denser and more resilient, while others are freer and more malleable. The ability of the multi-use myofascial massage device to apply both pressure and shear stress provides greater disruption to fibers resulting in greater tissue release in a limited amount of time. Practitioners, using available massage tools and techniques that are limited in the amount of and the kind of pressure they can apply, are often urged to not apply uninterrupted manual pressure for more than 2 minutes as the application of pressure beyond that time may cause damage to muscle tissue. This limit on the application of pressure results in limiting the amount of pressure required for tissue repair and thus, limits the amount of repair that can be achieved. In contrast, the claimed tool provides for the required amount of pressure required for tissue repair in the recommended amount of treatment time. The application of varying stressors can be useful for combating congestion and swelling resulting from inflammation. The proteins that form the vessels and structures of fascia are aligned along various axis and can grow to become dense and numerous over time. It is for this reason that a practitioner must treat fascia in various axis of motion that includes horizontal, vertical stress as well as pressure and shear stress.

Thus, it has been shown how to make and use multi-use myofascial massage device 10 to apply the pressure required to effectively treat muscle and fascia as well as being able to effectively pull fascia off of the skin. It has also been shown how the multiuse tool combines in one unit three integral pieces for the treatment of various muscular groups in an efficient manner, and that provides for individuals to take care of various specific body areas from the feet to the neck with ease and convenience as well as with minimal effort and time and in a cost-effective manner.

The foregoing description, for purposes of explanation, uses specific and defined nomenclature to provide a thorough understanding of the invention. However, it will be apparent to one skilled in the art that the specific details are not required to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims.

What is claimed is:

1. A therapeutic massage device, comprising:
a hollow tubular cylinder having a first end, a second end and an inner diameter;
a first therapeutic component, comprising of a roller rotatably disposed about the hollow tubular cylinder;
a second therapeutic component comprising of any one or more of: at least one roller, at least one sphere.
a third therapeutic component comprising of any one or more of: at least two spheres of similar radii or a combination of at least one sphere having a first radius and at least one sphere having a second radius; and
a connecting device connecting the hollow tubular cylinder with the second and third therapeutic components.

2. The device of claim 1, wherein the roller of the first therapeutic component further comprises of a compression and traction section and at least one suction cup positioned on the surface of the roller.

3. The device of claim 2, further comprising of at least one protrusion extending perpendicularly from the surface, wherein the protrusion is located at a position at any one of: close proximity with the at least one suction cup or inside the at least one suction cup;

4. The device of claim 1, wherein the hollow tubular cylinder comprises of a handle at each of the first and second ends.

5. The device of claim 4, wherein each handle is rotatably positioned about the hollow tubular cylinder.

6. The device of claim 1, wherein the connecting device is any one of: a cord, rope or wire.

7. The device of claim 6, herein the connecting device is any one of: several connected sections or one single length.

8. The device of claim 6, wherein the connecting device extends through the second therapeutic component, through the hollow tubular cylinder, through first and second fenestrations on the hollow tubular cylinder's surface, and through the third therapeutic component.

9. The device of claim 8 further comprising of a cord retrieval unit positioned about a section of the connecting device extending from the first and second fenestrations of the hollow tubular cylinder.

10. The device of claim 9, wherein the cord retrieval unit is structurally configured to allow for length adjustment of the connecting device.

11. The device of claim 1, wherein the second therapeutic component comprises of a large therapeutic roller or sphere flanked by two or more smaller rollers or spheres, wherein each of the smaller rollers or spheres have an outer diameter slightly less than the hollow tubular cylinder's inner diameter, wherein the large therapeutic roller or sphere has a diameter which is larger than the hollow tubular cylinder's inner diameter.

12. The device of claim 11, wherein each of the large roller or sphere and the smaller rollers or spheres comprise of an aperture through which the connecting device runs through.

13. The device of claim 1, wherein the third therapeutic component comprises of differently shaped objects in succession with each other, wherein each differently shaped object comprises of an aperture through which connecting device may run through.

14. The device of claim 13, wherein each differently shaped object has an outer diameter which is smaller than the hollow tubular cylinder's inner diameter.

15. The device of claim 1, wherein the second therapeutic component comprises of any one or more of: at least one roller or at least one sphere, wherein each at least one roller or at least one sphere has an outer diameter less than the hollow tubular cylinder's inner diameter, thereby enabling retraction of the second therapeutic component into the hollow tubular cylinder.

16. The device of claim 1, wherein the third therapeutic component comprises of any one or more of: at least one roller or at least one sphere, wherein each at least one roller or at least one sphere has an outer diameter less than the hollow tubular cylinder's inner diameter, thereby enabling retraction of the third therapeutic component into the hollow tubular cylinder.
